(19) United States
(12) Patent Application Publication
(10) Pub. No.: US 2007/0005434 A1
(43) Pub. Date: Jan. 4, 2007

(54) Systems and apparatuses for providing enhanced management of facilities offering food, beverages, and associated goods and services in a retail environment

(76) Inventors: David Roth, Chicago, IL (US); Rick Bacher, Chicago, IL (US)

Correspondence Address: PERKINS COIE LLP;PATENT-SEA, P.O. BOX 1247, SEATTLE, WA, 98111-1247, US

(21) Appl. No.: 11/119,336

(22) Filed: Apr. 28, 2005

Related U.S. Application Data
(60) Provisional application No. 60/604,504, filed on Aug. 24, 2004.
(60) Provisional application No. 60/565,984, filed on Apr. 28, 2004.

(51) Int. Cl. G06Q 30/00; G06Q 50/00

(52) U.S. Cl. 705/15

(57) ABSTRACT

Systems and apparatuses for providing enhanced management of facilities offering food, beverages, and associated goods and services in a retail environment are disclosed herein. In one embodiment of the invention, a quick-serve restaurant includes multiple above-counter cabinets, multiple below-counter storage bins, and a service bar positioned in front of the cabinets and the storage bins. In this embodiment, the above-counter cabinets hold commercially-recognizable, retail-sale packages of competitively-branded cereals for viewing by customers as they place their orders. The below-counter storage bins contain the competitively-branded cereals displayed in the above-counter cabinets. The service bar is configured for use by employees of the restaurant in preparing food orders that can include combinations of at least two or more of the cereals contained in the storage bins.

### CROSS REFERENCE TO RELATED APPLICATIONS

This application claims the benefit of co-pending U.S. Provisional Patent Application Ser. No. 60/604,504, entitled “METHODS AND SYSTEMS FOR PROVIDING FOOD, BEVERAGES, AND ASSOCIATED GOODS AND SERVICES IN A RETAIL ENVIRONMENT,” filed Aug. 24, 2004; and co-pending U.S. Provisional Patent Application Ser. No. 60/565,984, entitled “METHODS AND SYSTEMS FOR PROVIDING FOOD, BEVERAGES, AND ASSOCIATED GOODS AND SERVICES IN A RETAIL ENVIRONMENT,” filed Apr. 28, 2004; each of which is incorporated in the present application by reference.

This application is related to co-pending U.S. Non-Provisional patent application Ser. No. 11/078,686, entitled “METHODS AND SYSTEMS FOR PROVIDING FOOD, BEVERAGES, AND ASSOCIATED GOODS AND SERVICES IN A RETAIL ENVIRONMENT,” filed Mar. 11, 2005; and co-pending U.S. Non-Provisional Patent Application Serial No. [Attorney Docket No. 35766.8003US00], entitled “DATA COLLECTION, PROCESSING AND ANALYSIS SYSTEMS, SUCH AS FOR USE IN A FOOD SERVICE ENVIRONMENT,” filed Apr. 28, 2005; each of which is incorporated in the present application by reference.

### BACKGROUND

There are a wide variety of retail establishments at which consumers can purchase food to order. These include traditional “sit-down” restaurants as well as conventional “fast food” restaurants, not to mention grocery stores, supermarkets, and the like. While most grocery stores and supermarkets always carry a wide assortment of competitively-branded food products in their aisles, aside from beverages, restaurants rarely list two or more competitively-branded food products on their menus. Sit-down restaurants, for example, typically prepare meals from scratch and, as a result, their menus seldom list branded food products, much less competitively-branded food products. Furthermore, as a general rule, fast food restaurants only sell food under the franchise's brand. When fast food restaurants do offer foods under a different brand, this is typically done as a promotional or “limited time” offering only.

Occasionally, both sit-down and fast food restaurants will offer competitively-branded food products to their customers. Notwithstanding the typical liquor bar, however, these foods generally do not constitute core menu items. For example, while conventional sit-down or fast food restaurants may offer one or two different types of competitively-branded beverages to accompany a meal (e.g., Coke®, Pepsi®, etc.), they typically do not offer competitively-branded food products as the main course. Further, while conventional restaurants may offer one or two competitively-branded items as a dessert or condiment (e.g., Heinz® Ketchup versus A1 Steak Sauce®), they typically do not offer a wide range of competing products in these categories from which the customer can choose.

On or about Jun. 12, 2001, General Mills, Inc. opened the “Cereal Adventure” attraction at the Mall of America in Bloomington, Minn. The attraction, which has since closed down, was billed as a playful, interactive learning experience where kids could immerse themselves in the world of General Mills' cereals. Among the entertainment features, Cereal Adventure included “Cheerios® Play Park,” “Trix® Fruity Carnival,” and “Lucky Charms® Magical Forest.” In addition, at the “Wheaties® Hall of Champions,” visitors could pose for their own souvenir Wheaties box with their picture on it. The “Make Your Own Cereal” feature allowed visitors to create their own unique brand of cereal using General Mills' products, including creating the name of the cereal, box design, and contents. For a price, visitors could take their customized cereal home.

Kellogg's Cereal City USA™ in Battle Creek, Mich. is designed to entertain visitors while informing them about the cereal industry and Kellogg's products in particular. Cereal City is a combined museum, factory tour, and theme attraction that houses interactive exhibits, theaters, play areas, and a themed diner. For visitors who want a memento, they can take home a box of Kellogg's Frosted Flakes® cereal with their photo on it. Cereal City also includes a restaurant that offers fast food in addition to desserts, such as a “Fruit Loops® Sundae.”

### BRIEF DESCRIPTION OF THE DRAWINGS

FIG. 1 is a perspective view of a Quick Service Restaurant (QSR) configured in accordance with an embodiment of the invention.

FIG. 2 is an enlarged front view of a portion of the above-counter cabinets of the QSR of FIG. 1.

FIG. 3 is an enlarged isometric view of a portion of the storage bins of the QSR of FIG. 1.

FIG. 4 is a schematic top view of a QSR configured in accordance with an embodiment of the invention.

FIG. 5 is a schematic top view of a QSR configured in accordance with another embodiment of the invention.

FIG. 6 is an isometric view of a food order prepared in accordance with an embodiment of the invention.

FIG. 7 is an isometric view of a container for holding a combination of customer-selected, single category, independently-branded food products in accordance with an embodiment of the invention.

FIGS. 8A and 8B are isometric views of an eating utensil configured in accordance with an embodiment of the invention

FIG. 9 is a schematic diagram illustrating a suitable computer for employing aspects of the invention.

FIG. 10 is a schematic diagram illustrating a suitable system in which aspects of the invention may operate in a networked computer environment.

FIGS. 11A-11G illustrate a series of screen displays for selecting, ordering, and/or recording various combinations of competitively-branded food products in accordance with an embodiment of the invention.

FIGS. 12A-12D illustrate a series of screen displays for taking a customer order at a point-of-sale in accordance with an embodiment of the invention.

FIG. 13 illustrates a cereal bar maker for use with a QSR in accordance with an embodiment of the invention.

FIG. 14 is an isometric view of a mobile van for providing food, beverages, and/or associated goods and services in accordance with an embodiment of the invention.

FIG. 15 is an isometric view of mobile cart for providing food, beverages, and/or associated goods and services in accordance with another embodiment of the invention.

Note: The headings provided herein are for convenience only, and do not necessarily affect the scope or interpretation of the invention.

This disclosure contains material for which a claim for copyright is made. The copyright owner has no objection to the facsimile reproduction by anyone of the patent document or patent disclosure (including the Figures) as it appears in the Patent and Trademark Office patent file or records, but the copyright owner reserves all other copyright rights whatsoever.

### DETAILED DESCRIPTION

In broad terms, the following disclosure describes various systems and methods for providing food and other products to consumers in a convenient, retail setting. Certain details are set forth in the following description to provide a thorough understanding of various embodiments of the invention. Other details describing well-known structures and systems often associated with food service establishments are not set forth, however, to avoid unnecessarily obscuring the description of the various embodiments. Further, those of ordinary skill in the art will appreciate that other embodiments of the invention may be practiced without at least some of the details described herein.

Overview

In one embodiment described in greater detail below, a system for providing competitively-branded food products to consumers includes a quick-service restaurant (QSR) that displays the products in their readily-recognizable, retail-sale containers. As used herein, the term “competitively-branded” generally refers to foods that fall into the same category (e.g., cereals), but are produced by competing manufacturers (e.g., Kellogg's and General Mills) and sold under different brand names (e.g., Cheerios®, Fruit Loops®, Chex®, etc.). In one aspect of this embodiment, the system enables and encourages customers to order unique combinations of competitively-branded cereals to suit their own particular tastes. The orders are prepared by an employee of the QSR who combines the selection together with one or more toppings in a convenient, carry-out bowl having a closeable lid. The consumer may then add milk and enjoy the cereal on the premises, or seal the container and take it to enjoy later.

A QSR configured in accordance with another embodiment of the invention has the look and feel of a residential kitchen complete with over-the-counter food cabinets. The cabinets can have glass fronts to display an array of competitively-branded cereal boxes. Graphically displaying the different cereal choices in this manner gives the customers visual reference cues that are more compelling than simply displaying raw cereal in see-through holding bins. (As explained below, cereal is provided in drawer or bins in the QSR, but these bins are behind the counter and not accessible or typically viewable by consumers.) Displaying the readily-recognizable cereal boxes to the customers sparks an immediate taste-association with the customer, and lets him or her know immediately what types of cereal are offered and what he or she can expect. Conversely, merely identifying “granola” as a generic menu item often leaves the customer wondering what type (i.e., what brand) of granola is being offered. Indeed, it is quite rare to see competitively-branded foods advertised by their retail-sale containers as the core menu items in a restaurant setting, and even rarer to see a menu that encourages ordering unique combinations of such foods.

The QSR can include a number of entertainment features often associated with cereal and/or the cereal-eating experience. For example, in one embodiment, the QSR can include one or more viewing screens (e.g., video screens) that show familiar “Saturday morning” cartoons for viewing by customers.

In another embodiment, the QSR can provide hot cereal to order. For example, employees can make hot cereal mixtures (e.g., oatmeal, cream of wheat, rice porridge, etc.) one batch at a time using a pan and induction burner. In addition or alternatively, a rice cooker or other device can be advantageously employed to make the hot cereal and maintain it at temperature until sold/served.

Various hot cereal dishes prepared by the QSR can include oats. For example, in addition to commercially available “quick-cooking” oats, the QSR can also prepare dishes with rolled oats that have been presoaked for a period of time in water. In one embodiment, the oats are mixed with water (and optional salt) in proportions similar to conventional preparation instructions (e.g., in proportions of about 1 part oats to about 4-5 parts water; such as about 1 part oats to about 4.6 parts water) and held for a preset period of time prior to cooking. In one embodiment, the preset period of time is greater than about 15 minutes. In another embodiment, the preset period of time is greater than about 30 minutes, e.g., about 1 hour. In other embodiments, other time periods can be used to soak the oats before cooking. The relative proportions of the oats, water, and/or other ingredients, the hold time and the water temperature may be varied to achieve different results as desired. Presoaking the oats in this manner causes the oats to cook quicker and allows for the usage of longer cooking oats in this quick preparation setting.

The layout of the QSR is configured to permit efficient use of a small space, such that the induction burner, rice cooker, and/or dishwasher are effectively co-located. In this embodiment, customers move from a point-of-sale leftward to a central cereal mixing location. At this location, employees remove the selected cereals from storage bins located behind the counter, and mix the cereals together in an appropriate container. From here, the customers can view an arrangement of different toppings (both dry toppings and wet toppings) displayed on the counter, and can select one or more of the toppings for addition to the cereal order. After receiving their orders, the customers can proceed further leftward to add milk to the cereal at a milk station.

As explained below, the cereal is provided in various forms, not only hot or cold cereal in a bowl, but also blended with yogurt and/or other liquids to make smoothies or other beverages, as well as combined to form cereal bars or snack mixes. Other products can include steamed dairy or soy milk to which flavoring and/or other products can be added. Products can also include various types of frozen dairy and non-dairy food items combined with cereal, such as frozen dairy and non-dairy products sandwiched between two bakery items that include cereal. Products can further include muffins, coffee cakes and other baked goods made with various types of cereal. In addition, yogurt parfaits can include one or more layers of cereal between yogurt and fruit, and the yogurt may be frozen or replaced with ice cream. One or more different types of sweeteners may be added to cereal, including molasses, sugar, maple syrup and other flavored syrups, artificial sweeteners, honey, and so forth. Further, various toppings may be combined with the cereal, including bananas, raisins, candy, etc. Another menu item can include a “bowl” made with cereal, from which yogurt, ice cream and other food products (including more cereal) can be consumed before eating the bowl. Similar menu items include ice cream cone shells that are made from cereal. Still other menu items that may or may not include cereal can include custards, puddings, wraps (e.g., tortilla wraps), cookies, waffles, bagels, cakes, pies, pizza-like products, sandwiches, roll-ups, omelets, etc. In all of these embodiments, the products can be premade, or based on customer-selected cereals, toppings, or other ingredients.

In a further embodiment, each QSR location can include one or more point-of-sale devices that gather information. This information may be repackaged and sold to manufacturers of various products or items sold at the QSR locations. Indeed, much of the information gathered reflects market research of spending habits of customers at each QSR. Information gathered at each point-of-sale can include the following:
types of cereal ordered, cereal combinations ordered, cereal combinations ordered for particular customers and/or particular customer demographics;
toppings added to cereal (e.g., whether fresh versus dried fruit is more popular);
brand loyalty (whether customers mix cereals of the same brand or not);

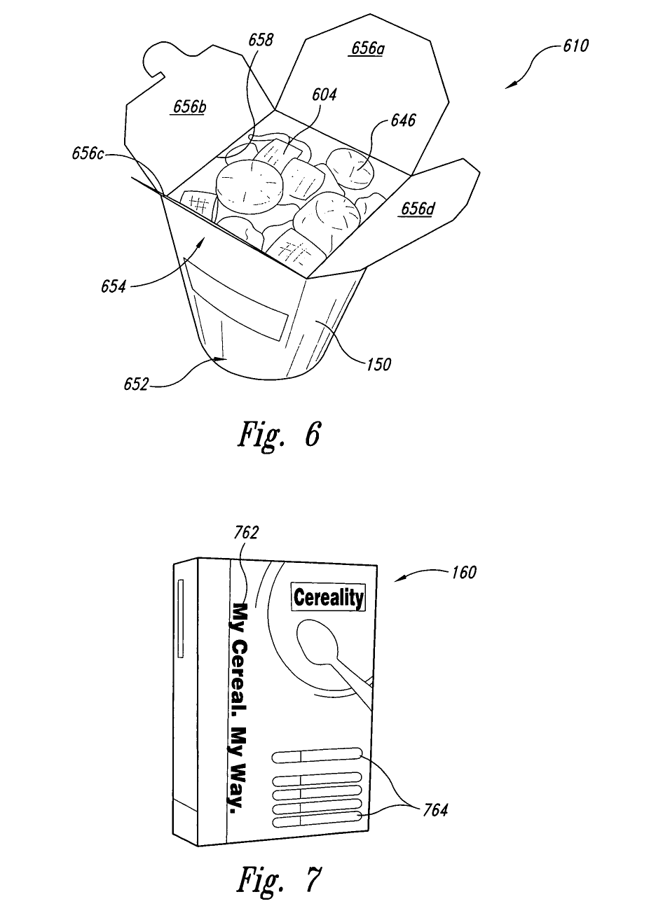

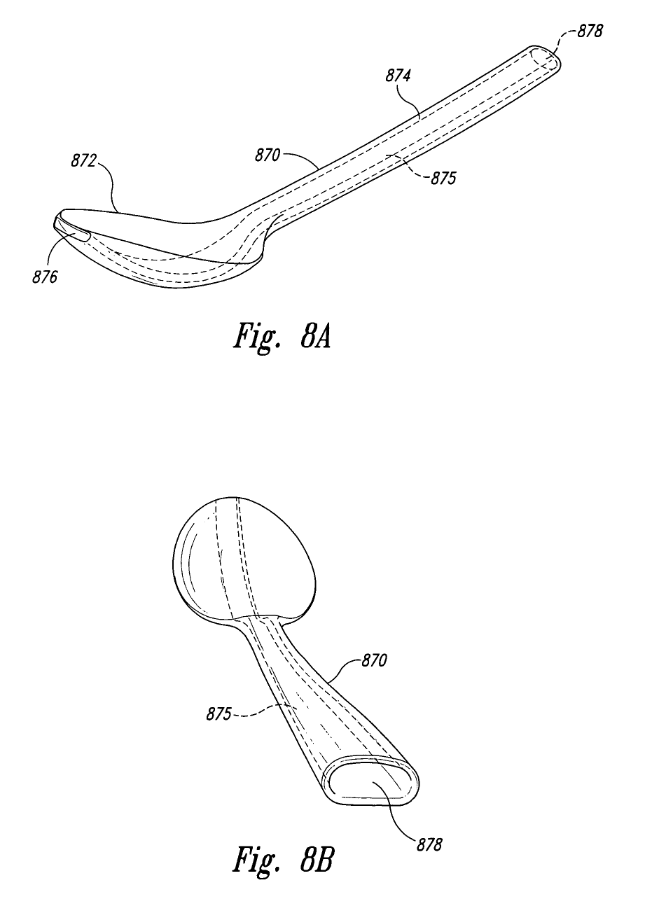

smoothies (“Slurrealities™”) and customer changes to predetermined smoothie recipes;
time-of-day habits;
volume purchased (e.g., bowls versus boxes of cereal versus cereal bars);
complementary sales (e.g., coffee);
use of frequent-user cards, stored-value cards, or the like;
repetitiveness (e.g., do customers order the same item or items each time?);
trials (e.g., at what rate does a new item break into the sales mix?);
seasonality (e.g., does the product sales mix vary throughout the year?); and
event purchasing (e.g., do external events impact product purchasing?)
   Many other types of information may be gathered, such as details on each sale, price of the sale, average sale per transaction per time of day, and so forth. Indeed, the point-of-sale device can gather information regarding each specific type of cereal or types of cereals added to a given order, the type of topping, the amount of each ingredient (cereal, topping, etc.), and so forth for every order. A suitable point-of-sale device can be any computer-driven point-of-sale device, and thus includes any type of computing device. Further, various aspects of the systems and methods described above can be implemented in a networked computer environment, such as the environment described in detail below with reference to FIGS. 6 and 7.
   Example of a Suitable Restaurant Configuration

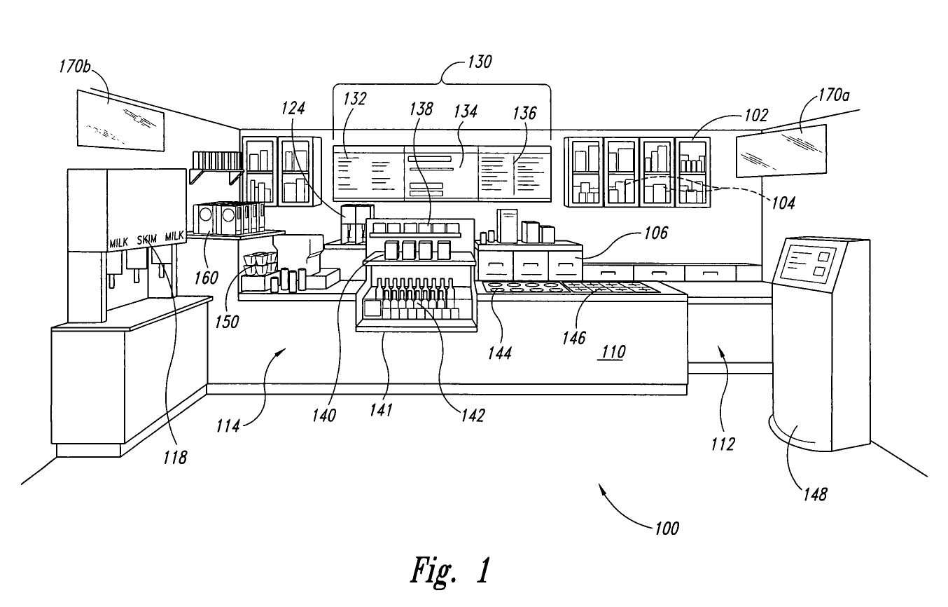

FIG. 1 is a front perspective view of a QSR 100 configured in accordance with an embodiment of the invention. The QSR 100 and selected variations thereof can be configured as a walk-up bar in public thoroughfares (e.g., college campuses, airports, train stations, shopping malls, etc.), or as a storefront business such as a café or restaurant. In one aspect of this embodiment, the QSR 100 includes multiple display cabinets 102 positioned above and behind a service bar 110. Each of the display cabinets 102 can hold multiple retail-sale packages 104 for multiple competitively-branded, single-category food products. For example, in the illustrated embodiment the display cabinets 102 hold and display the front sides of an array of breakfast cereal boxes (e.g., a Cheerios® box, a Frosted Flakes® box, a Capt'n Crunch® box, etc.). Arranging the competitively-branded cereal boxes in the display cabinets 102 in plain view of the customers (not shown) provides the customers with an immediate sensory connection to the various menu items on offer.

Multiple storage bins 106 are positioned behind the service bar 110 and generally below the display cabinets 102. As described below, the storage bins 106 contain, among other things, bulk supplies of the various breakfast cereals displayed in the cabinets 102. When a customer places an order, an employee of the QSR 100 (referred to in one embodiment as a “Cereologists”) removes the selected cereals from the storage bins 106 to prepare the order. In one embodiment, the storage bins 106 can include dispensing apparatus positioned toward the bottom of each bin and configured to deliver a pre-determined amount of cereal into a carry-out or serving container. This feature facilitates accurate product proportioning and an efficient first-in/first-out rotation of the product contained in the storage bins 106.

A menu board 130 is positioned above and behind the service bar 110 adjacent to the display cabinets 102. In the illustrated embodiment, the menu 130 is divided into three different sections. A first menu section 132 (“Your Cereal. Your Way.”) allows customers to choose from a list of different competitively-branded cereals and have them prepared as they desire. The competitively-branded cereals can include cereals currently sold in supermarkets, as well as a variety of other cereals. These other cereals can include, for example, nostalgic names (e.g., Quisp®) and other discontinued cereals (e.g., Vanilla Capt'n Crunch®) that may no longer be available on the supermarket shelves. These cereals can also include specialty cereals, such as organic cereals and popular cereals from other countries. When ordering from this menu section, customers can create cereal mixes just the way they like them. Specifically, they can mix and match their favorite brand-name cereals in a single bowl and add one or more different toppings. Alternatively, they can mix various brand-name cereals together and purchase them in bulk in a small to-go bag with an optional display window on the front (e.g., 3 scoops) or a large carry-out box (e.g., 6 scoops).

A second menu section 134 (“Your Cereal. Our Way.”) includes specialty cereal mixes created by the QSR 100. This menu section enables customers to experiment with both hot and cold cereal blends they may not have ever thought of, such as “Life Experience™” (i.e., Life® Cereal with almonds, honey, and topped with bananas). A third menu section 136 (“Your Cereal. A Whole New Way.”) offers various menu items that include cereal in creative ways. For example, in one embodiment this menu section can include smoothies (“Slurrealities™) made from different types of yogurt, cereal, fruit juice, etc. This menu section can also include various baked goods made from cereals, including cereal bars (“Cereality BarS™”) and snack mixes (“Cereality Bites™”). This section of the menu can also include various parfaits (“Parfaits Your Way™”) made with, for example, yogurt, cereal and fruit.

Many of the food items listed on the menu 130 are situated on or near the service bar 110 in plain view of the customers. For example, multiple different toppings 146 are arranged on the service bar 110 just to the left of an order station 112. The toppings can include, for example, sliced bananas, cinnamon apples, strawberries, raisins, sliced almonds, pumpkin seeds, Pop Rocks®, etc. Flavored milk crystals 144 can be placed next to the toppings 146 on the service bar 110. The milk crystals 144 can include various flavors, such as chocolate hazelnut, caramelized banana, red berry, etc. Parfaits 142 can be arranged in a display case 141 in a central portion of the service bar 110. As discussed above, the parfaits can include various flavors of yogurt combined with one or more different types of fruit, fruit juice, and/or branded cereal. Various cereal snack mixes 138 and cereal bars 140 can also be arranged in the display case 141 with the parfaits 142. The cereal snack mixes 138 can include various sweet and/or savory cereal mixes. For example, the cereal snack mixes 138 can include “Cinnamon-Oh-Man” (a mixture of cinnamon cereals, dried apples, raisins, etc.), “Tiki Torch Granola,” and “Honey Mustard Munch.” The cereal bars 140 can include, for example, “Raisin' the Roof Bran Snackin' Cake” made with Quaker Oats® and Quaker Bran Flakes®, and “S'mores Bar” made with Quaker Honey Graham Oh's®.

In addition to these cereal bars, in another embodiment of the QSR 100, customers can also order “customized” cereal bars. Customized cereal bars can include, for example, chewy granola bars and other types of bars made to order. In this regard, the QSR 100 can include a cereal bar pressing device (not shown in FIG. 1) or similar system that combines the customer-selected ingredients together and presses them into a bar without an associated cooking process. Customers can select from a list of core ingredients (e.g., oats, fruit, nuts, chocolate chips, etc.) to suit their taste. Further, the customers can also select from various nutritive and non-nutritive additives and/or coatings to enhance the product.

Also illustrated in FIG. 1 are multiple viewing screens 170 (identified individually as a first viewing screen 170a and a second viewing screen 170b). As mentioned above, in one embodiment the viewing screens 170 can be configured to show animated features for viewing by customers. The animated features can include familiar “Saturday morning” cartoons and other subject matter often associated with cereal and/or the breakfast dining experience.

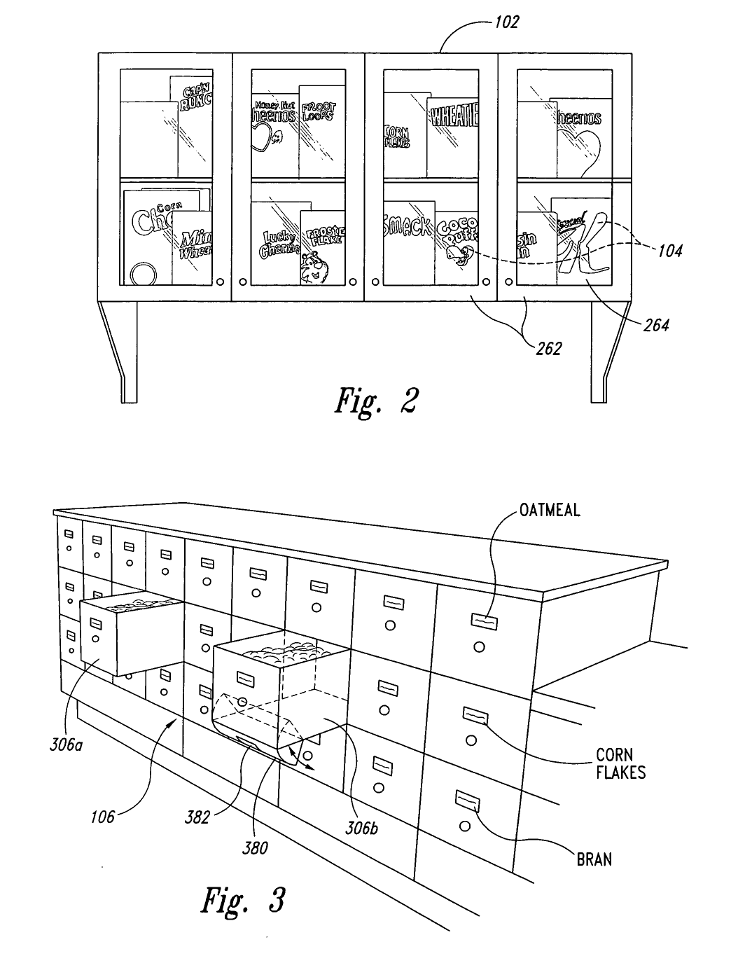

A customer (not shown) desiring to place an order at the QSR 100 approaches the order station 112 and places his or her order with an employee (also not shown) standing behind the service bar 110. After taking the order, the employee moves in the direction of customer flow and begins preparing the order. For example, if the customer orders a cereal combination, the employee removes the appropriate portions of the selected cereals from the storage bins 106 and mixes them together in a suitable bowl. In one embodiment, if the customer orders cereal “By the Bowl” for take-out or consumption at the QSR 100, the order can be prepared and served in a convenient carry-out container or bucket 150. The carry-out bucket 150 is described in more detail below with reference to FIG. 2. Alternatively, if the customer orders cereal “By the Bulk,” the order can be prepared in either a small (e.g., 3 scoops) to-go bag (not shown) or a large (e.g., 6 scoops) carry-out box 160. Various aspects of the carry-out box 160 are described in greater detail below with reference to FIG. 3.

After the employee has placed the selected cereals in the appropriate container, the employee can add whatever toppings 146 the customer ordered. Alternatively, the customer can choose to have the toppings placed in the container before the cereal, or in some other order of his or her choosing. In addition, the customer or employee can remove one or more of the parfaits 142, the cereal snack mixes 138, or the cereal bars 140 from the display case 141 to add to the order if desired. If the customer orders a smoothie (e.g., a “Slurreality™), the employee can prepare it using one or more of the blending devices 124 positioned behind the service bar 110. After taking any other steps necessary to complete the order, the employee moves toward a check-out station 114 to deliver the order to the customer.

If the customer wishes to consume the cereal immediately, the customer can take his or her cereal container over to a milk dispenser 118 and add one or more different types of milk. In the illustrated embodiment, the milk dispenser 118 can dispense various types of fresh dairy milk (e.g., whole, skim, or 2%) and/or various specialty milks such as soy milk. Alternatively, the customer may elect to not add milk right away, but instead take the cereal home for consumption at a later time.

In another aspect of this embodiment, the QSR 100 can include an interactive, stand-alone kiosk 148 with which customers can create unique cereal orders (i.e., “Invent-a-Blend”) and automatically send the orders to a QSR employee for preparation. Various aspects of the interactive kiosk 148 are described in greater detail below with reference to FIGS. 8A-8G.

FIG. 2 is an enlarged isometric view of the display cabinets 102 of the QSR 100 of FIG. 1. In this embodiment, each of the display cabinets 102 includes one or more doors 262 with see-through front portions 264. The see-through front portions 264 enable customers of the QSR to view the front sides of multiple retail-sale packages 104 positioned within the cabinets 102. In the illustrated embodiment, the retail-sale 104 are commercially-recognizable, competitively-branded cereal boxes. In other embodiments, other food products (including other types of dry food products) can be positioned within the cabinets 102 for viewing by the QSR customers.

FIG. 3 is an enlarged isometric view of a portion of the storage bins 106 of the QSR of FIG. 1. In one aspect of this embodiment, individual storage bins 306 (identified individually as storage bins 306a-b) can include a dispensing apparatus 380 positioned toward the bottom portion of the bin. The dispensing apparatus 380 can be configured to automatically dispense a predetermined amount of cereal into a container (not shown) through an outlet 382 when rotated downwardly by an employee of the QSR. In other embodiments, the storage bins 306 can include other types of known portion-control features to regulate the amount of cereal dispensed from the bins and to ensure a first-in, first-out product rotation. One advantage of these features is that they ensure consistency of order size. Another advantage of these features is that the first in, first out rotation helps to maintain product freshness.

In other embodiments, the QSR described herein can include other types of containers for storing and/or dispensing product. Such containers can include, for example, conventional storage bins that function like a typical drawer. With such bins, the product is placed into the bin, and taken out of the bin, from the top. In yet other embodiments, the cereal products can be contained in see-through bins that dispense product from an outlet positioned toward the bottom of the bin. Such bins allow customers to see the product before deciding on a particular selection.

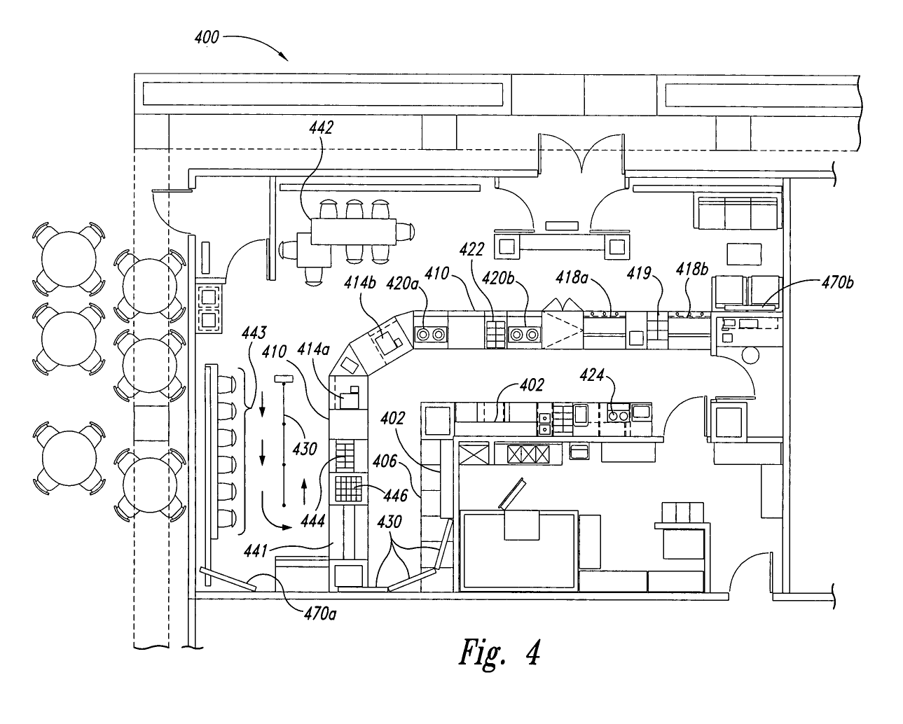

FIG. 4 is a schematic top view of a QSR 400 configured in accordance with an embodiment of the invention. The QSR 400 of this embodiment may be suitable for a street-side café setting that caters to walk-in customers. In this respect, the QSR 400 can include many features that are at least generally similar in structure and function to corresponding features of the QSR 100 described above with reference to FIG. 1. For example, the QSR 400 can include multiple display cabinets 402 positioned above multiple cereal storage bins 406. The storage bins 406 and the display cabinets 402 are positioned behind an L-shaped service counter 410.

The service counter 410 carries many of the items and appliances necessary for employees (not shown) of the QSR 400 to prepare orders for customers. For example, in the illustrated embodiment, a display case 441 is positioned at one end of the service counter 410, and carries various food items including parfaits, cereal snack mixes, and cereal bars. Dry toppings 446 and wet toppings 444 (e.g., flavored milk crystals) are positioned on the service bar 410 adjacent to the display case 441. As mentioned above, the dry toppings 446 can include sliced bananas, cinnamon apples, strawberries, raisins and other toppings that customers can have added to their orders. The wet toppings 444 can include various flavored crystals, such as chocolate hazelnut, caramelized banana, red berry, and others that can be added to milk.

Two point-of-sale stations 414 (identified individually as a first point-of-sale station 414a and a second point-of-sale station 414b) are positioned at an inner corner of the service bar 410. Each of the point-of-sale stations 414 can include a corresponding point-of-sale device (e.g., a cash register), a debit/credit card swipe, a computer terminal, a display screen, and/or other equipment for performing and/or recording sales transactions. As discussed in greater detail below, placement of the point-of-sale stations 414 in these locations can facilitate a smooth flow of customers along the service bar 410 from order placement to order delivery.

The service bar 410 further includes a first hot cereal preparation station 420a and a second hot cereal station 420b. In one embodiment, the hot cereal stations 420 can be used to prepare hot cereal dishes that include oatmeal, such as one or more of the hot cereal dishes described above that include “quick-cooking” oats or rolled oats. Hot cereal toppings 422 are positioned on the service bar 410 adjacent to the hot cereal stations 420. The hot cereal toppings 422 can include brown sugar, raisins, and other toppings often added to Cream of Wheat, oatmeal, and other hot cereal dishes.

A waffle preparation station 424 is positioned on the counter behind the service bar 410, and includes one or more waffle irons and associated equipment for making waffles. Two milk stations 418 (identified individually as a first milk station 418a and second a first milk station 418b) are positioned adjacent to a condiment station 419 on a far end of the service bar 410. The milk stations 418 are positioned in this location so that customers can add milk to their cereal orders as a final step before taking a seat at one of the tables 442 or counter seats 443.

To place an order at the QSR 400, customers queue up along a portable traffic barrier 430 and review a menu 430 positioned adjacent to the display cabinets 402. The customers can view cartoons or other media on a display screen 470a as they move along the traffic barrier 430. When ready to order, the customers proceed around the traffic barrier 430 and place their orders with an employee positioned behind the service counter 410. If an order includes cereal (e.g., a combination of two or more competitively-branded cereals) the employee can access the storage bins 406 to obtain the cereal portions selected by the customer. Similarly, if an order includes toppings and/or flavorings, the employee can access the dry toppings 446 and wet toppings 444 for the appropriate selections. From this point, the customer proceeds to one of the point-of-sale stations 414 for checkout. In addition, the customer can also order other food items (e.g., oatmeal, waffles, parfaits, cereal bars, snack mixes, etc.) at this time. After paying for his or her order, the customer can proceed to one of the milk machines 418 to add dairy milk (e.g., whole milk, skim milk, etc.) or non-dairy milk (e.g., soy milk, rice milk, etc.) to their cereal order if desired.

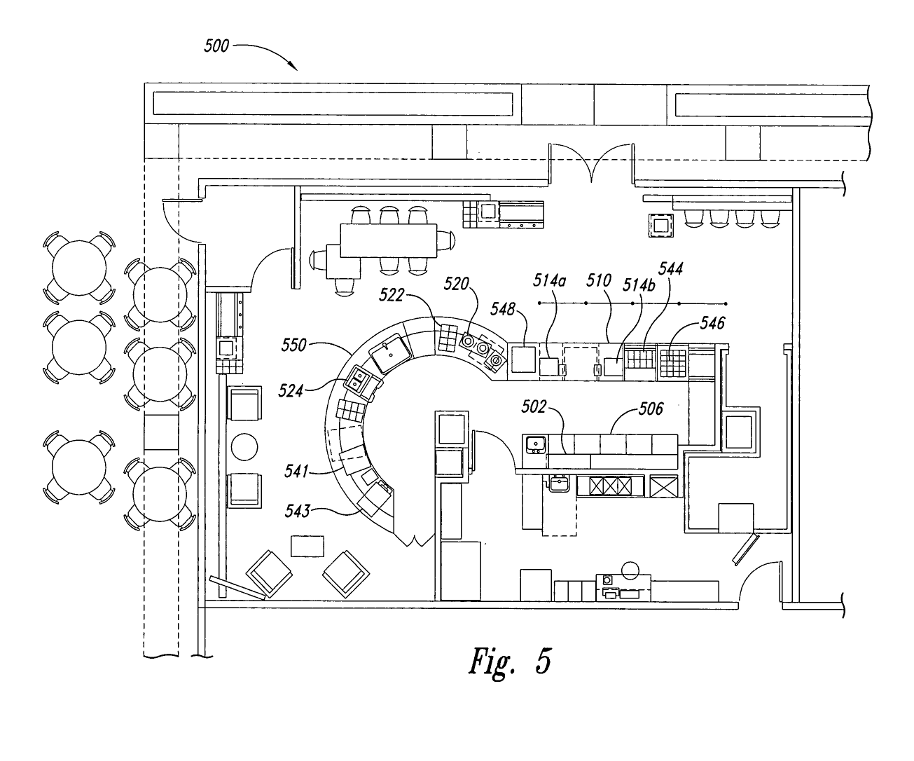

FIG. 5 is a schematic top view of a QSR 500 configured in accordance with another embodiment of the invention. Many features of the QSR 500 can be at least generally similar in structure and function to corresponding features of the QSR 400 described above with reference to FIG. 4. For example, the QSR 500 includes multiple display cabinets 502 positioned above cereal storage bins 506. As discussed above, the display cabinets 502 hold multiple commercially-recognizable, competitively-branded cereal boxes for viewing by customers. Bulk quantities of the displayed cereals are held in the storage bins 506.

The QSR 500 also includes a service bar 510 positioned in front of the display cabinets 502. Portions of the service bar 510 are at least generally similar in structure and function to corresponding portions of the service bar 410 described above with reference to FIG. 4. For example, the service bar 510 includes point-of-sale stations 514a and 514b. In the illustrated embodiment, dry toppings 546 and wet toppings 544 are positioned on one side of the point-of-sale stations 514, and a self-serve coffee station 548 is positioned on the opposite side.

In one aspect of this embodiment, the QSR 500 further includes a bowl-shaped or circular service bar 550 that enables employees of the QSR to prepare various food orders in full view of the customers. For example, the service bar 550 can include a blending station 524 for making smoothies (e.g., “Slurrealities”) and other blended drinks. In addition, the service bar 550 can also include a hot cereal station 520 with a corresponding selection of hot cereal toppings 522. Further, a display case 541 holding parfaits, cereal bars, cereal mixes, etc. can be positioned toward one end of the service bar 550 adjacent to a soft serve ice cream station 543.

As those of ordinary skill in the relevant art will appreciate, the QSR's 400 and 500 described above are but two examples of QSR's that can include features configured in accordance with the present invention. In another embodiment, a QSR configured in accordance with the present invention can include a drive-up window from which customers can pick up and/or pay for their orders. In this embodiment, the customers can place their orders from a free standing drive-up kiosk, or remotely from home via a telephone or computer operably connected to the QSR 500 via a suitable network.

Examples of a Prepared Food Order and Associated Containers

FIG. 6 is an isometric view of a food order 610 prepared in accordance with an embodiment of the invention. In one aspect of this embodiment, the food order 610 includes a mixture of competitively-branded cereals 604 and toppings 646 (e.g., bananas) combined in the convenient carry-out bucket 150 of FIG. 1. The carry-out bucket 150 includes a generally circular base portion 652 transitioning upward into a generally square top portion 654. Multiple closable flaps 656 (identified individually as flaps 656a-d) are hingeably attached to the top portion 654, and can be foldably interleaved to close off an opening 658 in the top portion 654.

In one embodiment, the carry-out bucket 150 can be manufactured from a suitable paperboard material. In other embodiments, the bucket 150 and variations thereof can be manufactured from other materials, including plastics, metals, and other suitably durable materials. Further, various aspects of the carry-out container 150 can be at least generally similar in structure and function to one or more of the containers disclosed in U.S. Pat. No. 5,358,175, which is incorporated herein in its entirety by reference. One feature of the bucket 150 is that it can hold liquids, such as milk, without leaking. One advantage of this feature is that it enables the bucket 150 to be used as a serving bowl or as a convenient transport/storage container.

FIG. 7 is an enlarged isometric view of the carry-out box 160 of FIG. 1, configured in accordance with an embodiment of the invention. Various aspects of the carry-out box 160 can be at least generally similar in structure and function to a conventional cereal box. In the illustrated embodiment, however, the carry-out box 160 includes a number of distinguishing features, including a unique label 762 (e.g., “My cereal. My way.”) and multiple data-entry fields 764. In the data-entry fields 764, the customer can write various information about the particular contents of the container 760. This information can include, for example, the customer's name, a coined name for the particular cereal and/or topping combination, the inspiration for the particular combination, the date of purchase, and other information such as suggested toppings or other food items that may go well with the particular combination. In addition or alternatively, all or a portion of the data-entry fields 764 can be automatically filled out by an associated computer system after entry of customer information.

Examples of Eating Utensils

FIGS. 8A and 8B are different isometric views of an eating utensil 870 configured in accordance with an embodiment of the invention. Referring to FIGS. 8A and 8B together, the utensil 870 includes a scoop portion 872 attached to a handle portion 874. An internal passage 875 extends through the utensil 870 between an inlet 876 positioned toward a tip of the scoop portion 872 and an outlet 878 positioned toward an opposite end of the handle portion 874.

The utensil 870 can be used in a number of different ways. In one embodiment, for example, the utensil 870 can be used to remove food (e.g., cereal and milk) from a suitable container (e.g., the carry-out bucket 150 of FIG. 2). In this embodiment, the customer can manipulate the utensil 870 like a conventional spoon to remove food from the container with the scoop portion 872. In addition, if the customer wishes to draw milk or other liquid from the container, the customer can do so by sucking on the outlet 878 when the inlet 876 is submerged in the liquid.

Example of a Suitable Data Processing System

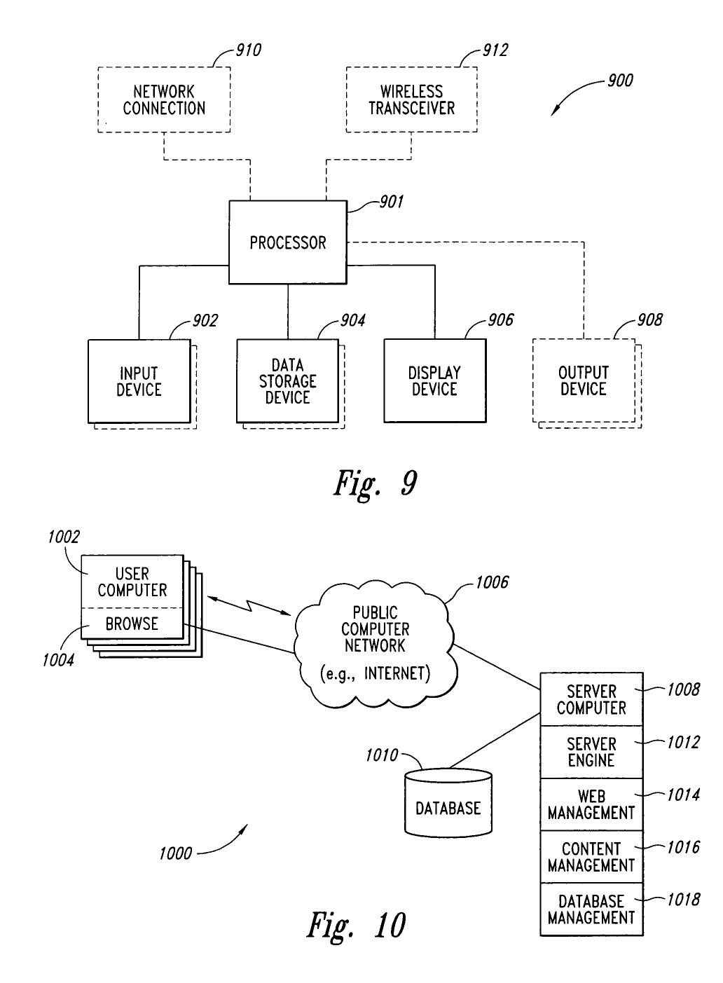

Various aspects of the restaurants described above can be implemented or facilitated with use of a suitable computing system. These aspects include, for example, food ordering and customer data gathering. FIG. 9 and the following discussion provide a brief, general description of a computing environment suitable for use with the present invention. Although not required, aspects and embodiments of the invention will be described in the general context of computer-executable instructions, such as routines executed by a general-purpose computer, e.g., a server or personal computer. Those skilled in the relevant art will appreciate that the invention can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like. The invention can be embodied in a special purpose computer or data processor that is specifically programmed, configured or constructed to perform one or more of the computer-executable instructions explained in detail below. Indeed, the term “computer,” as used generally herein, refers to any of the above devices, as well as any data processor.

Various aspects of the invention can also be practiced in distributed computing environments, where tasks or modules are performed by remote processing devices which are linked through a communications network, such as a Local Area Network (“LAN”), Wide Area Network (“WAN”) or the Internet. In a distributed computing environment, program modules or sub-routines may be located in both local and remote memory storage devices.

Other aspects of the invention may be stored or distributed on computer-readable media, including magnetic and optically readable and removable computer discs, stored as firmware in chips (e.g., EEPROM chips), as well as distributed electronically over the Internet or over other networks (including wireless networks). Those skilled in the relevant art will recognize that some portions of the invention may reside on a server computer, while other portions may reside on a client computer. Further, data structures and data transmissions particular to aspects of the invention are also encompassed within the scope of the invention.

Referring to FIG. 9, one embodiment of the invention employs a computer 900 (e.g., a personal or portable computer, workstation, stand-alone kiosk, point-of-sale device, mobile phone, etc.) having one or more processors 901 coupled to one or more user input devices 902 and data storage devices 904. The computer 900 is also coupled to at least one output device, such as a display device 906, and one or more optional output devices 908 (e.g., a printer, a plotter, speakers, tactile or olfactory output devices, etc.). The computer 900 may be coupled to external computers, such as via an optional network connection 910, a wireless transceiver 912, or both.

The input devices 902 may include a keyboard and/or a pointing device such as a mouse. Other input devices are possible such as a microphone, joystick, pen, game pad, scanner, digital camera, video camera, and the like. The data storage devices 904 may include any type of computer-readable media that can store data accessible by the computer 900, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to a network such as a local area network (LAN), wide area network (WAN) or the Internet (not shown in FIG. 9).

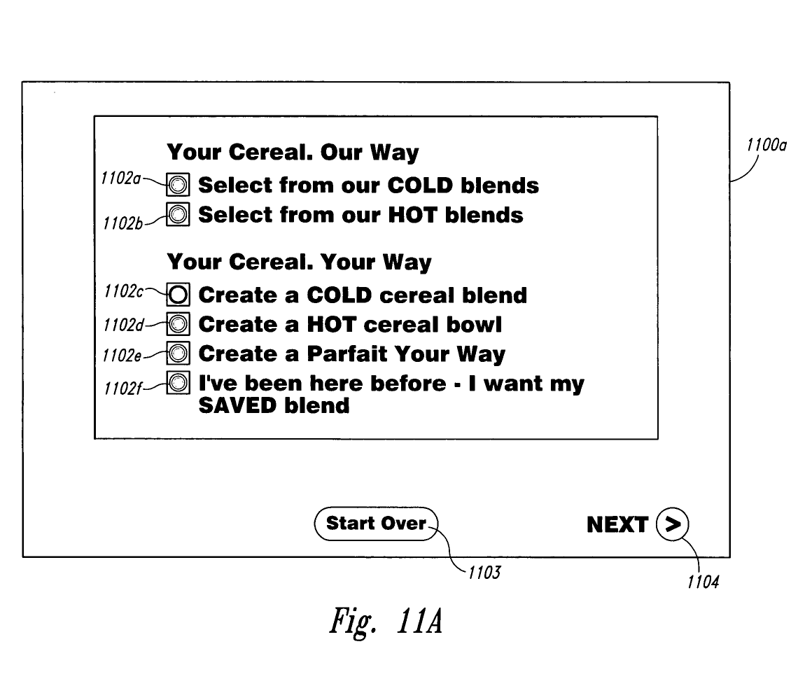

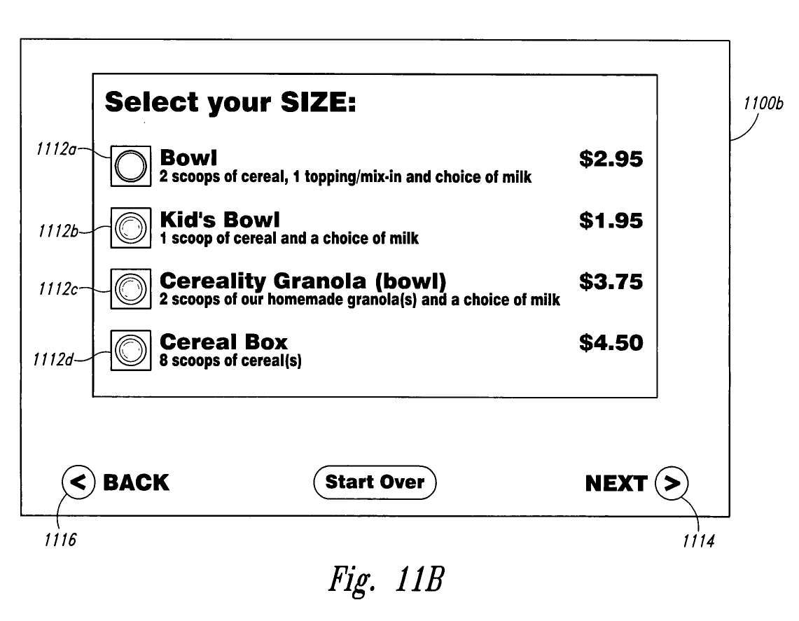

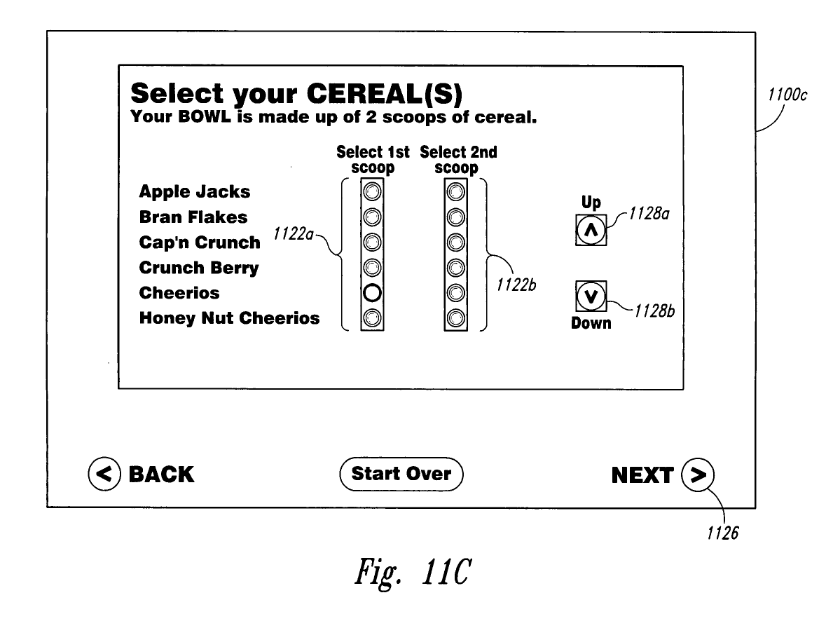

Aspects of the invention may be practiced in a variety of computing environments. FIG. 10, for example, illustrates a suitable computer system 1000 having a web interface and one or more user computers 1002. Each of the user computers 1002 can include a browser program module 1004 that permits the computer to access and exchange data with the Internet 1006, including web sites within the World Wide Web portion of the Internet. The user computers may be substantially similar to the computer 900 described above with reference to FIG. 9. User computers may include other program modules such as an operating system, one or more application programs (e.g., word processing or spreadsheet applications), and the like. The computers may be general-purpose devices that can be programmed to run various types of applications, or single-purpose devices optimized or limited to a particular function or class of functions.

At least one server computer 1008, coupled to the Internet or World Wide Web (“Web”) 1006, performs many or all of the functions for receiving, routing, and storing of electronic messages, such as web pages, audio signals and electronic images. While the Internet is shown, a private network, such as an intranet, may likewise be used herein. The network may have a client-server architecture in which one computer is dedicated to serving other client computers; or it may have other architectures, such as peer-to-peer, in which one or more computers simultaneously act as both servers and clients. A database 1010 or databases, coupled to the server computer(s) 1008, stores many of the web pages and content exchanged between user computers.

The server computer 1008 can include a server engine 1012, a web page management component 1014, a content management component 1016 and a database management component 1018. The server engine 1012 performs basic processing and operating-system-level tasks. The web page management component 1014 handles creation and display or routing of web pages. Users may access the server computer 1008 by means of a URL associated therewith. The content management component 1016 handles most of the functions in the embodiments described herein. The database management component 1018 performs storage and retrieval tasks with respect to the database, queries to the database, and storage of data such as cereal inventory, point-of-sale data, etc.

One skilled in the relevant art will appreciate that the concepts of the invention can be used in various environments other than location based environments or the Internet. In general, a display description may be in HTML, XML or WAP format, email format or any other format suitable for displaying information (including character/code-based formats, algorithm-based formats (e.g., vector generated), and bitmapped formats). Also, various communication channels, such as local area networks, wide area networks, or point-to-point dial-up connections, may be used instead of the Internet. The system may be conducted within a single computer environment, rather than a client/server environment. Also, the user computers may comprise any combination of hardware or software that interacts with the server computer, such as television-based systems and various other consumer products through which commercial or noncommercial transactions can be conducted. The various aspects of the invention described herein can also be implemented in or for an e-mail environment.

Examples of Customer Kiosk Functionality

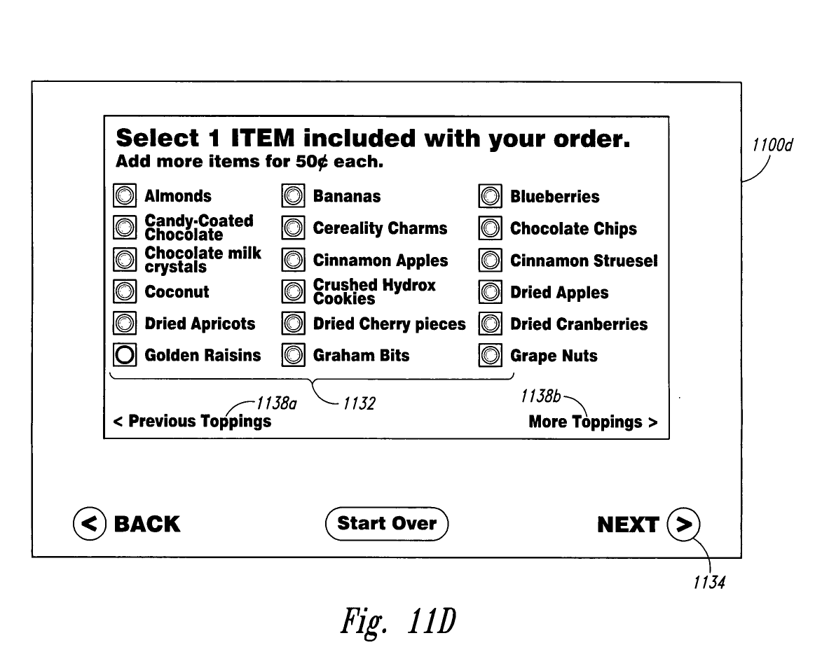

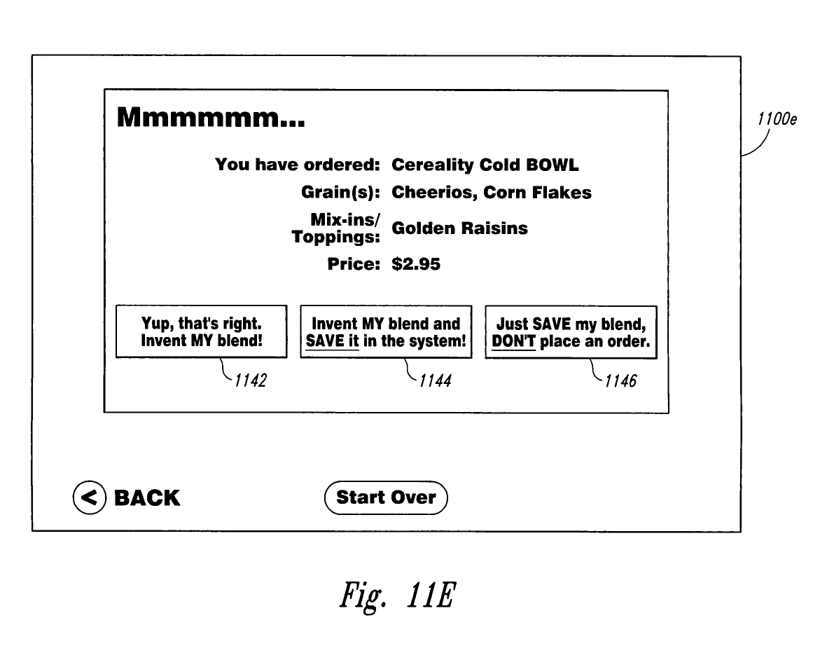

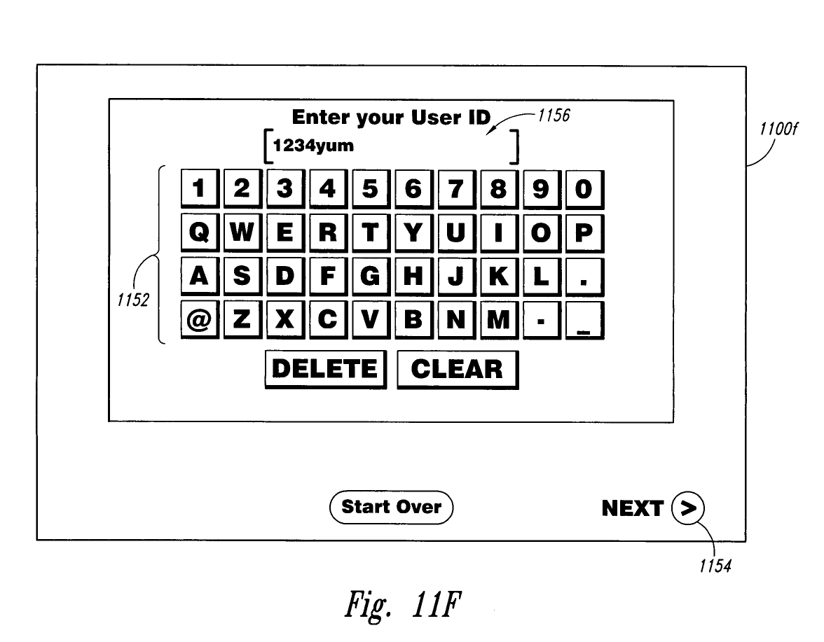

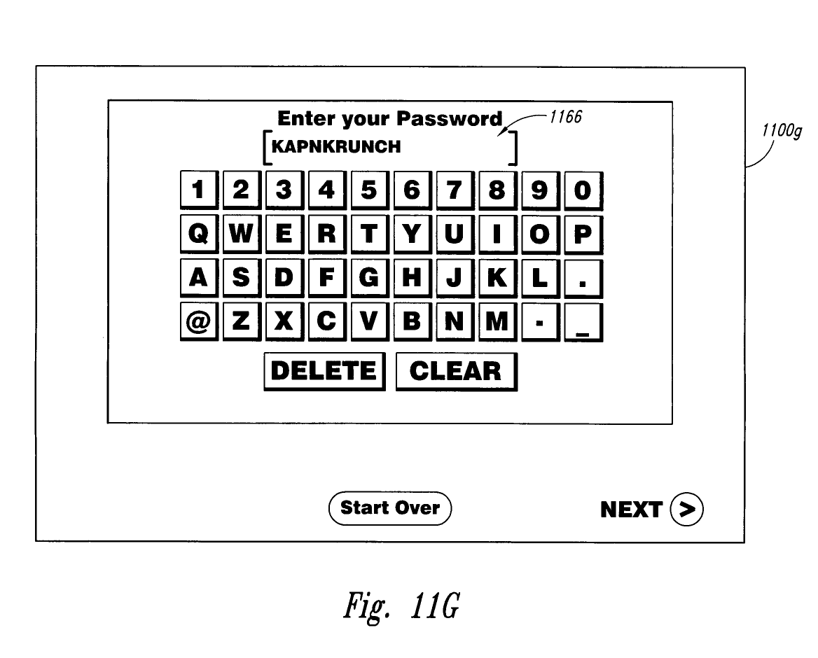

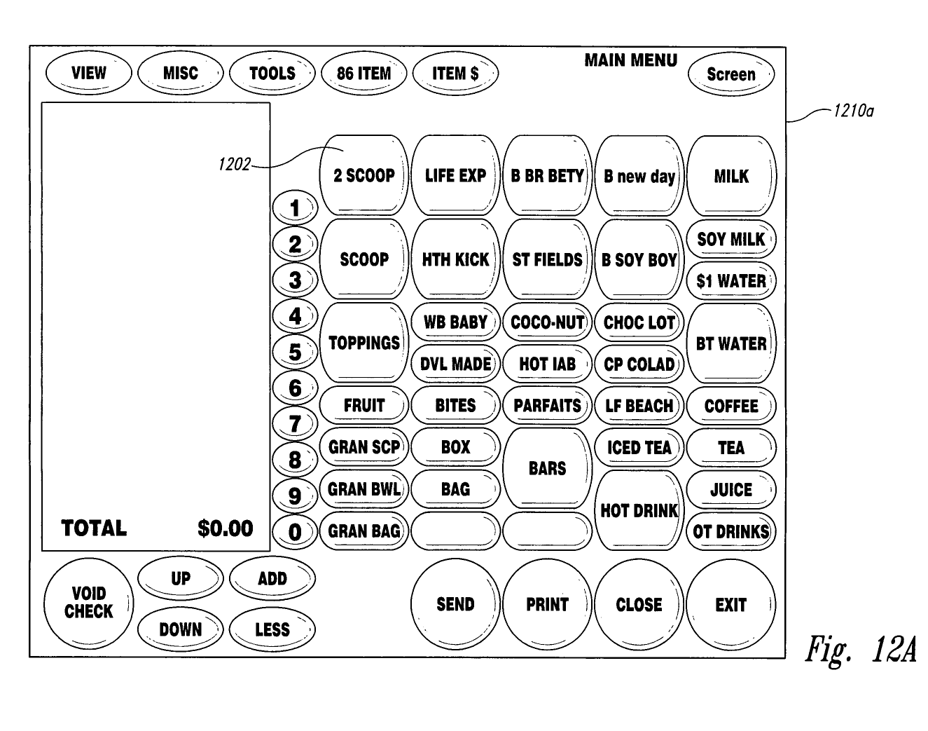

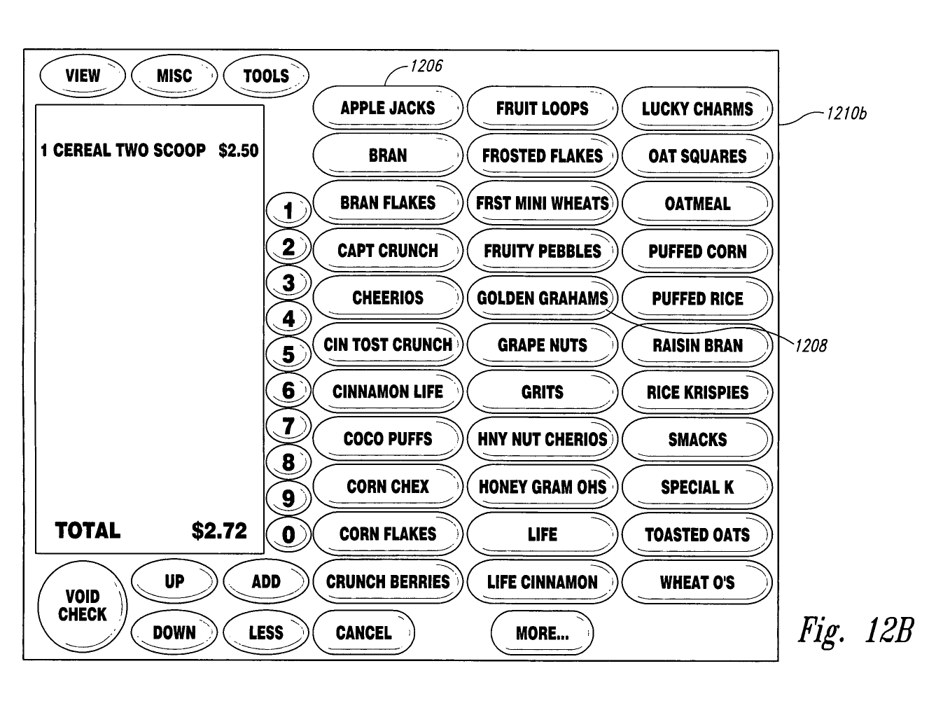

FIGS. 11A-G illustrate a series of screen displays 1100a-g with which a customer can invent a unique blend of different foods, place an order for the blend, store the blend for later recall, and/or retrieve and order a previously stored blend. In the illustrated embodiment, the screen displays 1100a-g relate to cereal blends and associated toppings. In other embodiments, however, the screen displays 1100a-g and/or variations thereof can be used to invent and order other food combinations. In one embodiment, the screen displays 1100 can be implemented with the interactive kiosk 148 described above with reference to FIG. 1. In other embodiments, all or a portion of the screen displays 1100 can be implemented with a different computer system, such as a personal computer located in a customer's home or office which accesses the screen displays via a web server computer.

FIG. 11A illustrates a screen display 1100a that enables a customer to select an existing cereal blend or create his or her own unique cereal blend (i.e., “invent-a-blend”). For example, the customer can select a first button 1102a to select an existing cold cereal blend, or a second button 1102b to select an existing hot cereal blend. Alternatively, the customer can select a third button 1102c to create a cold cereal blend, or a fourth button 1102d to create a hot cereal blend. On the other hand, if the customer instead preferred a parfait, he or she can select a fifth button 1102e to create a parfait.

If the customer has used the kiosk 148 before to remotely create and/or order a menu item, the customer can select a sixth button 1102f. This button brings up another screen display (not shown) which lists the customer's earlier creations. The customer can then select an earlier creation, and an order for that creation will be immediately transmitted to a remote operator (e.g., an employee of the QSR 100 of FIG. 1) for preparation.

If the customer desires to change a selection on the screen display 1100a, the customer can do so by selecting a “Start Over” button 1103. Once the customer has made his or her final selection from the screen display 1100a, the customer can select a “Next” button 1104 to proceed with the ordering process. For example, if the customer selects the third button 1102c to “Create a COLD cereal blend” and then selects the Next button 1104, this brings up the screen display 1100b illustrated in FIG. 11B.

The screen display 1100b enables the customer to select a quantity of cereal for purchase. For example, the user can select a first button 1112a to order a “Bowl” (i.e., two scoops of cereal, one topping/mix-in, and choice of milk). Alternatively, the user can select a second button 1112b for a “Kid's Bowl” (i.e., one scoop of cereal and choice of milk), a third button 1112c for a bowl of “Cereality Granola,” and a fourth button 1112d for a “Cereal Box” (i.e., 8 scoops of cereal). The customer can select a “Back” button 1116 to return to the previous screen and change a portion of the order. After selecting the desired order size from the screen display 1100b, the customer can select a “Next” button 1114 to proceed with the ordering process. For example, if the customer selects the first button 1112a to order a Bowl, this brings up the screen display 1100c illustrated in FIG. 11C.

The screen display 1100c enables the customer to select from multiple different, competitively-branded cereals to fill his or her Bowl. In the illustrated embodiment, the customer is allowed to select two scoops of cereal because he or she previously selected “Bowl” as the desired serving size, and a Bowl includes two scoops of cereal. The first cereal selection is made using a first group of selector buttons 1122a, and the second selection is made using a second group of selector buttons 1122b. An “Up” button 1128a allows the customer to scroll up through the list of different cereals, and a corresponding “Down” button 1128b lets the customer scroll down through the list. After the customer has selected the desired cereals, the customer can select a “Next” button 1126 to proceed to the screen display 1100d illustrated in FIG. 11D.

The screen display 1100d enables the customer to select one or more toppings. Each of a multiple different toppings (e.g., almonds, raisins, bananas, etc.) is associated with a corresponding button 1132. The customer can select a topping by clicking on the appropriate button. The customer can view additional toppings by selecting either a “Previous Toppings” button 1138a or a “More toppings” button 1138b. After one or more toppings have been selected, the customer can select a “Next” button 1134 to proceed to the screen display 1100e illustrated in FIG. 11E. Although the screen displays 1100c and 1100d of the illustrated embodiment include textual descriptions of the various cereals and toppings available, both of these screen displays can also or instead include graphics describing various aspects (e.g., brands, logos, etc.) of the offerings.

The screen display 1100e enables the customer to complete his or her order. In the illustrated embodiment, the customer's order is displayed on the screen. After checking the order, the customer can select a Send button 1142 to automatically send the order to a remote operator (e.g., an employee at a Point-of-Sale counter of the QSR 100) for preparation. Alternatively, the user can select a Send/Save button 1144 that will additionally save the customer's order in an associated database from which the user can retrieve the order at a later date. On the other hand, if the customer desires to just save the order without placing it at this time, the customer can do so by selecting a Save button 1146. Selecting either the Send/Save button 1144 or the Save button 1146 automatically brings up the screen display 1150 illustrated in FIG. 11F.

The screen display 1100f enables the customer to enter a unique code that will be associated with the customer's saved order. In this regard, the screen display 1100f includes a graphical representation of a keyboard 1152 with which the customer can enter a User ID in a display field 1156. Once this has been done, the customer can select a “Next” button 1154 to proceed to the screen display 1100g illustrated in FIG. 11G. The screen display 1100g is generally similar in structure and function to the display screen 1100f, and can be used by the customer to enter a unique Password in a display field 1166 in a similar manner. In the illustrated embodiment, the Password is used in conjunction with the User ID to ensure that only the originating customer has access to his or her stored orders.

The interactive kiosk 148 illustrated in FIG. 1, and the related screen displays 1100a-g described above with reference to FIGS. 11A-11G, can be utilized in one embodiment as follows. First, a customer approaches the kiosk 148 and inputs his or her order (e.g., a combination of various cereals and toppings) in the manner described above with reference to FIGS. 11A-11G. Once the customer has input the order, the order is automatically transmitted to an output device (e.g., a point-of-sale device) located at the service bar 110 (FIG. 1). In one embodiment, the output device can include a paper printer that outputs a printed recipe for the desired food combination. At this time, one of the QSR staff (e.g., a “Cerealologist”) can prepare the order based on the printed output. In this manner, the Cerealologist can be preparing the customer's order as the customer makes their way from the kiosk 148 to the check-out station 114 (FIG. 1). When the customer arrives, their order is ready to go. In this embodiment, the customer can pay for the order at the check-out station 114. In another embodiment, however, the customer can pay for the order at the kiosk 148 via suitable payment functionality (e.g., a credit card reader, a bill and/or coin slot, a user interface configured to receive a customer account no., etc.)

In another embodiment, the kiosk 148 can transmit the customer's order to a automatic food-preparing apparatus (not shown) instead of a point-of-sale device. In one aspect of this embodiment, the food-preparing apparatus can be configured to automatically prepare the customer's order in response to receiving an appropriate signal from the kiosk 148. In addition, in this embodiment the apparatus can also package the customer's order and dispense it proximate to the point-of-sale.

The kiosk 148 can also be configured to provide customers with recommended menu items and combinations, and nutritional information about various menu choices. For example, in one embodiment, the kiosk 148 can provide customers with recommended menu items tailored to fit specified dietary and/or nutritional preferences or restrictions.

Examples of Point-of-Sale Device Functionality

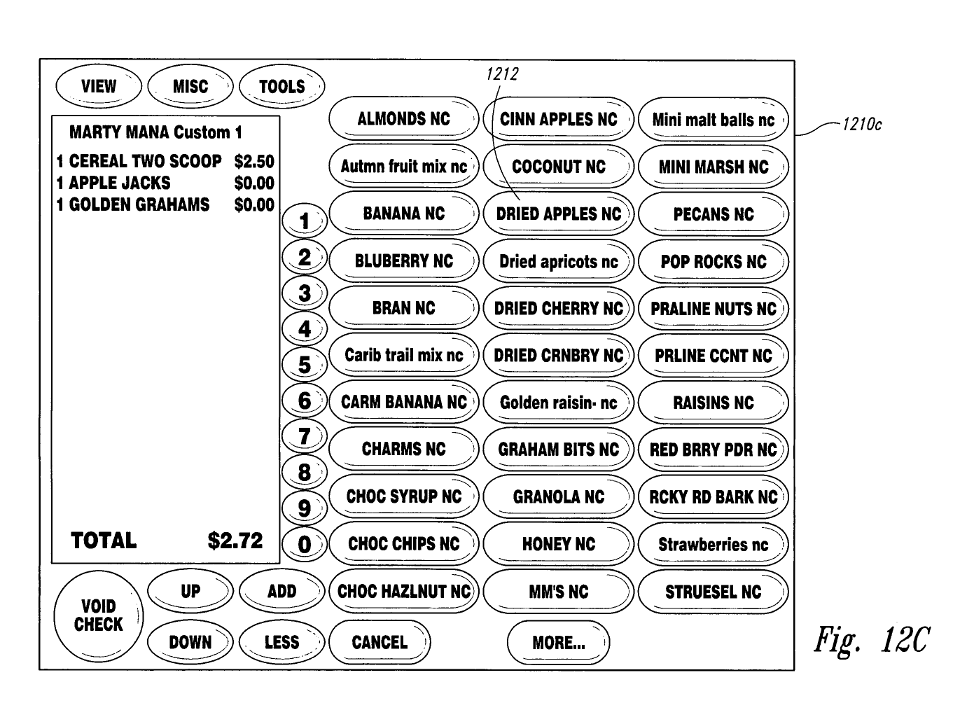

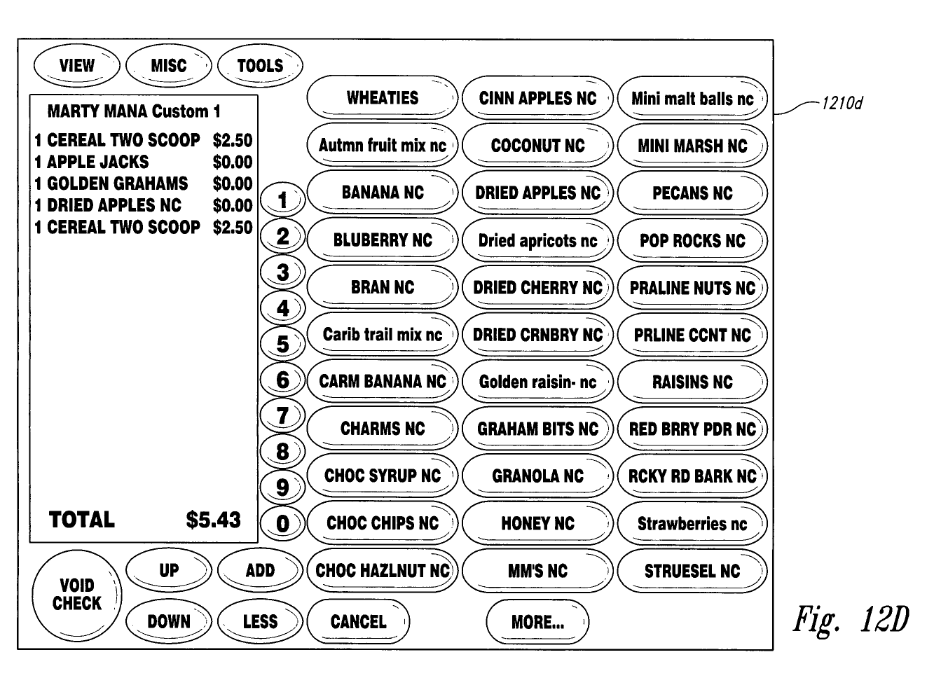

FIGS. 12A-12D illustrate various point-of-sale screen displays 1210a-d configured in accordance with an embodiment of the invention. In this embodiment, the screen displays 1210a-d can be presented in sequential order to a point-of-sale staff or cashier to facilitate taking a customer's order at the QSR 100 described above with reference to FIG. 1. In FIG. 12A, a screen display 1210a lists various food product options available to the customer. These options can include, for example, one or two scoops of a particular type of cereal, fruit toppings, cereal bars, parfaits, liquids to mix with the cereal (e.g., milk, soy, etc.), and drinks such as coffee and tea. If the cashier selects a “2 SCOOP” button 1202, the screen display 1210b of FIG. 12B is displayed.

As FIG. 12B illustrates, the screen display 1210b includes a list of cereals from which the customer can choose. If, for example, the customer tells the cashier that he or she desires Apple Jacks and Golden Grahams, then the cashier accordingly selects an “Apple Jacks” button 1206 and a “Golden Grahams” button 1208. Doing so generates the display screen 1210c illustrated in FIG. 12C.

The display screen 1210c illustrates the various types of fruit and other toppings available. In this particular embodiment, one topping is free with a two scoop cereal order. If, for example, the customer desires dried apples, the cashier selects a “Dried Apple” button 1212. This selection generates the screen display 1210d illustrated FIG. 12D. The display screen 910d shows the cashier the customer's order and the associated price.

Examples of a Food Product Makers

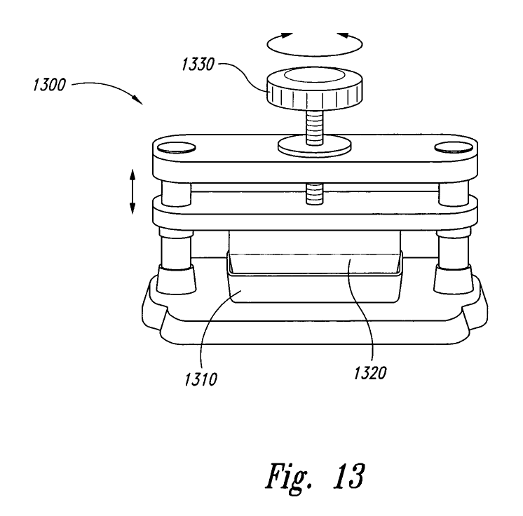

FIG. 13 is an isometric view of a cereal bar maker 1300 that can be used with one or more of the QSR's described above in accordance with an embodiment of the invention. The bar maker 1300 can be generally similar in structure and function to one or more known, commercially-available cereal bar makers. In the illustrated embodiment, the bar maker 1300 includes a form 1310 configured to hold the cereal bar ingredients. The ingredients can include various customer-selected cereals, nuts, fruit pieces, chocolate chips, vitamin supplements, etc. The bar maker 1300 further includes a press 1320 which is movably coupled to knob 1330. After placing the ingredients in the form 1310, the knob 1320 is rotated about its axis to move the press 1320 downwardly and compact the ingredients in the form 1310. The press 1320 is then retracted so that the finished bar can be removed from the form 1310 for delivery to the customer. Although the cereal bar maker 1300 of FIG. 13 uses a press with a screw-drive, in other embodiments, other cereal bar makers can utilize a press that is driven downwardly by a hand-operated lever.

Examples of Modular and Mobile Food Service Providers

Various aspects of the present invention have been described above in the context of quick service restaurants. However, the present invention is not limited to these particular embodiments. Indeed, in other embodiments, various aspects of the invention can be implemented in a modular or mobile format. As used herein, the term “modular format” can refer generally to a cereal bar that is at least partially pre-fabricated and then transported to an operating site in modules. Possible operating sites can include, for example, transportation venues such as airports, train stations, bus terminals, and the like. Other locations can include shopping malls, department stores, sports venues, movie theaters, and the like.

In these embodiments, the food service outlet is modular in nature so that the operator can determine the range of services a particular location will offer. Further, the modular nature of the design enables the operator to order only the particular modules he or she needs in a particular location. Such embodiments may be advantageous for facilitating the franchising of cereal bars and other food service outlets for operation by individual owner/operators. For example, in one embodiment, the modular format allows an owner/operator franchisee to order a particular cereal bar arrangement in modular form, and have it delivered to his or her location by the franchisor, who then leaves the system in place for the business owner to operate.

In addition, the modular concept enables the owner/operator to scale the cereal bar to meet the needs of a particular location. In some embodiments, this scaling can include only offering limited menu items at particular locations. For example, in at least some of the modular locations, the menu may be tailored to include only a limited number of commercially-available cereals and other products, or only special blends (e.g., “signature blends”) of premixed cereals.

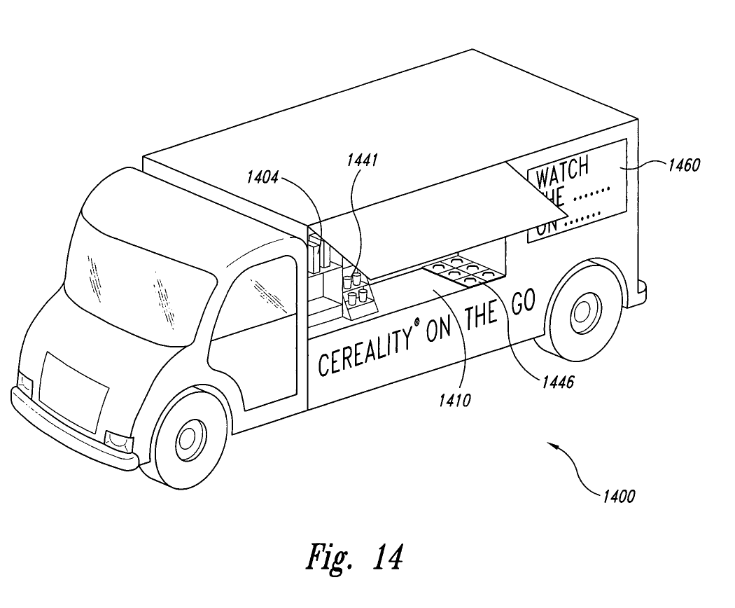

As used herein, the term “mobile format” can refer generally to various mobile systems configured to provide food, beverages, and/or related services to remote and/or outdoor locations that may not have ready access to food or a particular type of food (e.g., cereal and/or other breakfast-related products). FIG. 14, for example, is an isometric view of a mobile food van 1400 configured in accordance with an embodiment of the invention. In one aspect of this embodiment, the mobile food van 1400 includes many of the features of the QSR 100 described above with reference to FIG. 1. For example, the mobile food van 1400 can include a service bar 1410 from which an operator (not shown) can provide cereals (e.g., mixed cereal combinations) to customers. The mobile food van 1400 can further include multiple toppings 1446 which the customers can add to their cereal orders. Further, the mobile van 1400 can additionally display multiple cereal boxes 1404 corresponding to a number of different brands of popular cereals. In addition, the mobile van 1400 can also include a display case 1441 containing other food items, such as parfaits, cereal snack mixes, cereal bars, etc. Accordingly, the mobile van 1400 includes many of the features of the QSR 100 so that those who can not travel to such a QSR can instead buy the same or similar foods and services at the mobile van 1400. The mobile van 1400 can additionally include third-party signage and other advertisements 1460 as an additional source of revenue.

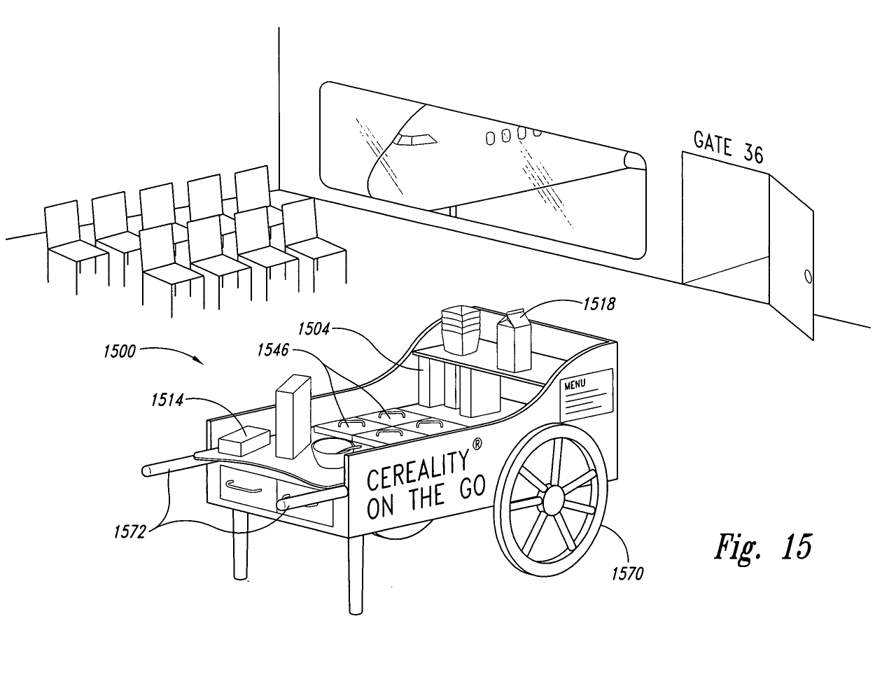

FIG. 15 is an isometric view of a mobile food cart 1500 configured in accordance with another embodiment of the invention. In one aspect of this embodiment, the mobile food cart 1500 includes two or more wheels 1570 so that the cart 1500 can be easily moved around an airport or other public venue by a single operator using cart handles 1572. In one aspect of this embodiment, the mobile food cart 1500 can include various features of the QSR 100 described above with reference to FIG. 1 for the purpose of serving travelers and other persons cereal and other food items. For example, the mobile food cart 1500 can include multiple types of cereal 1504 and multiple types of toppings 1546. In addition, the cart 1500 can also include one or more containers 1518 for providing milk or non-dairy beverages to customers to mix with their cereal. The cart 1500 can further include a point-of-sale device 1514. The mobility of the cart 1500 enables a single person operator to move the cart about a public venue to provide customers with a meal that is at least generally similar to a meal one could obtain by visiting the QSR 100 described above with reference to FIG. 1.

Unless the context clearly requires otherwise, throughout the foregoing description and the associated examples, the words “comprise,” “comprising,” and the like are to be construed in an inclusive sense, as opposed to an exclusive or exhaustive sense; that is to say, in the sense of “including, but not limited to.” Additionally, the words “herein,” “above,” “below,” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list, and any combination of the items in the list.

The above detailed description of various embodiments of the invention is not intended to be exhaustive or to limit the invention to the precise form disclosed. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times. Where the context permits, words in the above Detailed Description using the singular or plural number may also include the plural or singular number respectively.

The teachings of the invention provided herein can be applied to systems other than the system described herein. Similarly, the elements and acts of the various embodiments described above can be combined to provide further embodiments.

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above Detailed Description. While the above description details certain embodiments of the invention and describes the best mode contemplated, no matter how detailed the above appears in text, the invention can be practiced in many ways. As noted above, particular terminology used when describing certain features or aspects of the invention should not be taken to imply that the terminology is being redefined herein to be restricted to any specific characteristics, features, or aspects of the invention with which that terminology is associated. Accordingly, the actual scope of the invention encompasses not only the disclosed embodiments, but also all equivalent ways of practicing or implementing the invention.

From the foregoing, it will be appreciated that specific embodiments of the invention have been described herein for purposes of illustration, but that various modifications may be made without deviating from the spirit and scope of the invention. For example, aspects of the invention described in the context of particular embodiments may be combined or eliminated in other embodiments. Further, while advantages associated with certain embodiments of the invention have been described in the context of those embodiments, other embodiments may also exhibit such advantages, and not all embodiments need necessarily exhibit such advantages to fall within the scope of the invention. Accordingly, the invention is not limited, except as by the appended claims.

While certain aspects of the invention are presented below in certain claim forms, the inventors contemplate the various aspects of the invention in any number of different claim forms. For example, while one or more aspects of the invention may be recited as embodied in a computer-readable medium, other aspects may likewise be embodied in a computer-readable medium. Accordingly, the inventors reserve the right to add additional claims after filing the application to pursue such additional claim forms for other aspects of the invention.

While certain aspects of the invention are presented below in certain claim forms, the inventors contemplate the various aspects of the invention in any number of different claim forms. For example, while one or more aspects of the invention may be recited as embodied in a computer-readable medium, other aspects may likewise be embodied in a computer-readable medium. Accordingly, the inventors reserve the right to add additional claims after filing the application to pursue such additional claim forms for other aspects of the invention.

I/We claim:

1. A quick-serve restaurant comprising:
multiple above-counter cabinets having see-through doors;
multiple commercially-recognizable, retail-sale packages for competitively-branded cereals, wherein at least some of the competitively-branded cereals are from different manufacturers, and wherein the multiple retail-sale packages are positioned within the above-counter cabinets for viewing by customers of the quick-serve restaurant;
multiple below-counter storage bins positioned beneath the above-counter cabinets, wherein each of the below-counter storage bins contains one of the competitively-branded cereals corresponding to one of the retail-sale packages positioned within the display area, and wherein the below-counter storage bins are configured for use by a server of the quick-serve restaurant;
a service bar holding multiple cereal toppings in view of the customers of the quick-serve restaurant, wherein the service bar is configured for use by the server to prepare a food order received from one of the customers, and wherein the food order includes a combination of at least two or more of the cereals contained in the below-counter storage bins and at least one of the cereal toppings held by the service bar; and
multiple carry-out containers, wherein the server places the food order in one of the carry-out containers prior to presenting the food order to the customer.

2. The quick-serve restaurant of claim 1 wherein the below-counter storage bins are configured for first-in, first-out rotation of the contents contained within.

3. The quick-serve restaurant of claim 1 wherein the storage bins include dispensing apparatuses configured to dispense a pre-determined amount of cereal into a receptacle.

4. The quick-serve restaurant of claim 1 wherein the carry-out containers include leak-proof, paperboard containers.

5. The quick-serve restaurant of claim 1 wherein individual ones of the carry-out containers include a generally circular base portion and a generally square opening with closable flaps configured to releasably interlock.

6. The quick-serve restaurant of claim 1, further comprising a self-serve milk station configured to dispense at least two different types of milk.

7. The quick-serve restaurant of claim 1, further comprising a menu board positioned at least approximately above the service bar, the menu board having at least one menu item composed of a first customer-selected, competitively-branded cereal and a second customer-selected, competitively-branded cereal mixed together in one of the carry-out containers with a topping of the customer's choosing.

8. The quick-serve restaurant of claim 1 wherein the customer is a first customer and the food order is a first order for a first combination of the cereals contained in the storage bins, and wherein the quick-serve restaurant further comprises an interactive kiosk with which a second customer can place a second food order for a second combination of the cereals contained in the storage bins.

9. The quick-serve restaurant of claim 1, further comprising:
a point-of-sale device configured to receive information related to the food order, the information including at least a first name of a first competitively-branded cereal and a second name of a second competitively-branded cereal; and
a database operably connected to the point-of-sale device and configured to store at least a portion of the information received by the point-of-sale device.

10. The quick-serve restaurant of claim 1, further comprising:
a point-of-sale device configured to receive information related to the food order, the information including at least a first quantity of a first competitively-branded cereal and a second quantity of a second competitively-branded cereal; and
a database operably connected to the point-of-sale device and configured to store at least a portion of the information received by the point-of-sale device.

11. The quick-serve restaurant of claim 1, further comprising at least one viewing screen configured to show animated cartoon features for viewing by the customers.

12. The quick-serve restaurant of claim 1, further comprising a cereal bar maker for making cereal bars containing customer-selected ingredients.

13. A quick-serve restaurant comprising:
a display area;
multiple retail-sale packages for multiple competitively-branded cereals, the multiple retail-sale packages being positioned within the display area for viewing by customers of the quick-serve restaurant;
multiple storage bins, wherein each of the storage bins contains a cereal corresponding to one of the retail-sale packages positioned within the display area, wherein the storage bins are positioned and configured for use by a server of the restaurant; and
a service bar positioned near the storage bins, wherein the service bar is configured for use by the server to prepare a food order received from one of the customers, wherein the food order includes a combination of at least two or more of the cereals contained in the storage bins.

14. The quick-serve restaurant of claim 13 wherein the display area includes at least one cabinet having a see-through door through which the customers can view the retail-sale packages.

15. The quick-serve restaurant of claim 13 wherein the display area includes at least one cabinet having a see-through door through which the customers view the retail-sale packages, and wherein the at least one cabinet is positioned behind the service bar and above the storage bins.

16. The quick-serve restaurant of claim 13, further comprising multiple carry-out containers, wherein the server places the food order in one of the carry-out containers prior to presenting the food order to the customer.

17. The quick-serve restaurant of claim 13 wherein individual ones of the carry-out containers include a leak-proof, paperboard base portion.

18. The quick-serve restaurant of claim 13, further comprising multiple carry-out containers, wherein the server places the food order in one of the carry-out containers prior to presenting the food order to the customer, and wherein individual ones of the carry-out containers include a generally circular base portion and a generally square opening.

19. The quick-serve restaurant of claim 13, further comprising a self-serve milk dispenser from which the customer can dispense milk onto the food order in a carry-out container.

20. The quick-serve restaurant of claim 13, further comprising a menu having at least one menu item composed of a first customer-selectable, competitively-branded cereal and a second customer-selectable, competitively-branded cereal combined in one of the carry-out containers.

21. The quick-serve restaurant of claim 13, further comprising a menu having at least one menu item composed of a first customer-selected, competitively-branded cereal and a second customer-selected, competitively-branded cereal mixed together in one of the carry-out containers with a topping of the customer's choosing.

22. The quick-serve restaurant of claim 13 wherein the customer is a first customer and the food order is a first order for a first combination of the cereals contained in the storage bins, and wherein the quick-serve restaurant further comprises an interactive kiosk with which a second customer can place a second food order for a second combination of the cereals contained in the storage bins.

23. The quick-serve restaurant of claim 13, further comprising:
a point-of-sale device configured to receive information related to the food order; and
a database operably connected to the point-of-sale device and configured to store at least a portion of the information received by the point-of-sale device.

24. The quick-serve restaurant of claim 13, further comprising:
a point-of-sale device configured to receive information related to the food order, the information including at least a first name of a first competitively-branded cereal and a second name of a second competitively-branded cereal; and
a database operably connected to the point-of-sale device and configured to store at least a portion of the information received by the point-of-sale device.

25. The quick-serve restaurant of claim 13, further comprising:
a point-of-sale device configured to receive information related to the food order, the information including at least a first quantity of a first competitively-branded cereal and a second quantity of a second competitively-branded cereal; and
a database operably connected to the point-of-sale device and configured to store at least a portion of the information received by the point-of-sale device.

26. The quick-serve restaurant of claim 13, further comprising at least one viewing screen configured to show animated cartoon features to the customers.

27. A system for providing food in a quick-serve restaurant setting, the system comprising:
means for displaying multiple retail-sale packages of competitively-branded, dry food products produced or marketed by two different companies;
means for presenting a menu option to a customer, wherein the menu option includes a first customer-selectable, competitively-branded dry food product and a second customer-selectable, competitively-branded dry food product;
means for processing a request from the customer for the menu option; and
means for combining the first and second dry food products together for carry-out in response to processing the request from the customer.

28. The system of claim 27, further comprising means for storing bulk portions of the competitively-branded, dry food products, wherein the means for storing are separate from the means for displaying.

29. The system of claim 27, further comprising means for storing bulk portions of the competitively-branded, dry food products, wherein the means for storing are separate from the means for displaying, and wherein the means for combining include means for removing a first portion of the first dry food product and a second portion of the second dry food product from the means for storing.

30. The system of claim 27 wherein the means for combining include means for mixing the first and second dry food products together in a leak-proof, paperboard container.

31. The system of claim 27 wherein the means for combining include means for mixing the first and second dry food products together in a paperboard container having a generally circular base portion and a generally square opening.

32. The system of claim 27, further comprising means for recording information related to the request from the customer in a database, the information including at least the names of the first and second dry food products.

33. The system of claim 27, further comprising means for recording information related to the request from the customer in a database, the information including at least the time of the request and the names of the first and second dry food products.

34. The system of claim 27, further comprising means for recording information related to the request from the customer in a database, the information including at least a first quantity of the first dry food product and a second quantity of the second dry food product.

35. The system of claim 27 wherein the means for processing a request from the customer for the first menu option include means for receiving a remote request from the customer.

36. The system of claim 27 wherein the means for processing a request from the customer for the first menu option include means for receiving a request from a remote computer.

37. The system of claim 27 wherein the means for receiving a request from the customer for the first menu option include means for receiving a request from a kiosk.

38. An eating utensil comprising:
a handle configured to be grasped by a person, the handle including a first aperture;
a scoop attached to the handle and configured to carry food, the scoop including a second aperture; and
an internal passageway extending through the utensil from the first aperture in the handle to the second aperture in the scoop.

39. The eating utensil of claim 38 wherein the scoop includes a distal tip portion, and wherein the second aperture is positioned at least proximate to the distal tip portion.

40. The eating utensil of claim 38 wherein the scoop includes an outer periphery, and wherein the second aperture is positioned proximate to the outer periphery.

41. The eating utensil of claim 38 wherein the handle, the scoop, and the internal passage are integrally formed from a single piece of material.

42. The eating utensil of claim 38 wherein the scoop includes a distal tip portion and the handle includes a proximal tip portion, wherein the first aperture is positioned on the proximal tip portion of the handle, and wherein the second aperture is positioned on the distal tip portion of the scoop.

43. The eating utensil of claim 38 wherein the first aperture faces a first direction and the second aperture faces a second direction opposite to the first direction.

44. A method for serving food in a retail setting, the method comprising:
receiving a customer selection of a first ingredient;
receiving a customer selection of a second ingredient;
combining the first ingredient with the second ingredient in a bar making device;
compressing the first ingredient against the second ingredient in the bar making device to form a bar; and
delivering the bar to the customer in return for payment.

45. The method of claim 44 wherein receiving a customer selection of a first ingredient includes receiving a customer selection of a first, commercially branded breakfast cereal.

46. A method of providing breakfast cereal in a public venue, the method comprising:
stocking a vehicle with multiple competitively-branded breakfast cereals, wherein the multiple competitively-branded breakfast cereals are manufactured by at least two different cereal manufacturers;
moving the vehicle to a publicly accessible area;
parking the vehicle in the publicly accessible area;
receiving a request from a customer for a first portion of a first one of the competitively-branded breakfast cereals and a second portion of a second one of the competitively-branded breakfast cereals;
in response to receiving the request from the customer, combining the first and second portions of the first and second competitively-branded breakfast cereals together in a carry-out container; and
presenting the carry-out container to the customer in exchange for payment.

47. The method of claim 46 wherein stocking a vehicle includes stocking a van, and wherein moving the vehicle includes driving the van to a curb-side location.

48. The method of claim 46 wherein stocking a vehicle includes stocking a hand-cart, and wherein moving the vehicle includes pushing the hand-cart.

49. The method of claim 46 wherein stocking a vehicle includes stocking a hand-cart, and wherein moving the vehicle includes pushing the hand-cart in a public transportation venue.

50. The method of claim 46 wherein receiving a request from a customer includes receiving a request for a first portion of a first cereal from a first cereal manufacturer and a second portion of a second cereal from a second, different cereal manufacturer.

51. The method of claim 46 wherein combining the first and second portions of the breakfast cereals together in a carry-out container includes placing first and second portions of brand-name cereal in a leak-proof, paperboard container.

52. The method of claim 46 wherein combining the first and second portions of the breakfast cereals together in a carry-out container includes placing first and second portions of brand-name cereal in a paperboard container having a generally circular base portion and a generally square top portion.
